(19) United States
(12) Patent Application Publication
(10) Pub. No.: US 2003/0078976 A1
(43) Pub. Date: Apr. 24, 2003

(54) Method and apparatus for facilitating romance and/or sexual relations

(76) Inventor: Andrew Scott Gordon, Los Angeles, CA (US)

Correspondence Address: Andrew Gordon, 733 N. Kings Road #322, Los Angeles, CA, 90069, US

(21) Appl. No.: 10/271,131

(22) Filed: Oct. 15, 2002

Related U.S. Application Data
(60) Provisional application No. 60/330,281, filed on Oct. 18, 2001.

(51) Int. Cl. G06F 15/16

(52) U.S. Cl. 709/205

(57) ABSTRACT

A method and apparatus for facilitating interaction between a human individual and other individuals with whom he or she has indicated an interest in or attraction for, or with whom he or she has a shared ‘mutual attraction’. A computer system receives inputs from various individuals indicating an attraction for or interest in other individuals. Individuals are directly notified through the system of the other individual's interest regardless of whether or not a ‘mutual attraction’ exists. When the system determines that a ‘mutual interest’ exists between individuals, it indicates the current availability or logged-on status of both individuals. In addition, the system provides a means for a user to indicate, change and communicate his type or level of interest in another individual. The system also provides a user with the ability to track and view all those individuals who have indicated an interest in or attraction for him or her, regardless of whether or not a ‘mutual attraction’ exists between both individuals.

### CROSS-REFERENCE TO RELATED APPLICATIONS

This application claims the benefit of PPA Application No. 60/330,281 filed on Oct. 18, 2001.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a method and apparatus for facilitating interaction between a human individual and other individuals with whom he or she has indicated an interest in, or with whom he or she has a shared ‘mutual attraction’.

2. Background of the Invention

It is often very difficult for an individual to meet another individual or individuals with whom he or she shares common interests. Similarly, it is often times even more difficult for an individual to meet and interact with another individual or individuals with whom he or she shares romantic feelings and/or sexual interests. Many factors contribute to making this a very challenging and time-consuming process.

In today's society, people lead increasingly busy lives and have little time to spend on developing and nurturing relationships that may or may not ultimately lead to romance and/or sexual relations. Time available for socializing at bars, clubs or other traditional gathering places is becoming scarce, making it more and more difficult to find and identify potential partners.

In addition, many people tend to be shy and are hesitant to initiate first contact on their own with an individual or individuals they find of romantic or sexual interest for fear of rejection or embarrassment. In many instances, the ‘risks’ of potential embarrassment or rejection prevent interaction. Often times individuals will not express their true feelings for or interest in other individuals because of the erroneous assumption that the other individual does not share this mutual interest. Also, not knowing how the other individual might react often times causes both individuals to remain silent and not communicate their interests or feelings for one another. Additionally, in many cases, individuals will ask a 3^{rd} party, like a friend or close associate, to approach others that they are interested in romantically or sexually as a way to avoid personal embarrassment and ‘save face’ in the event that the other individual does not feel similarly. All of these behaviors arise due to the inability to directly communicate one's sexual or romantic interests in another individual or individuals in a ‘low-risk’ and non-threatening way, and thus significantly reduces the likelihood of finding a potential partner for romance and/or sexual relations.

Even after a potential partner has been identified, it can be equally difficult to determine if a mutual romantic and/or sexual ‘match’ exists between individuals. The process of determining whether or not people have mutual romantic and/or sexual feelings for one another involves the interpretation of a subtle mix of words, gestures, mannerisms, and body language, all of which can be easily misinterpreted, leading to mixed signals and erroneous conclusions concerning reciprocal interest. Based on the personal and subjective interpretation of these often-subtle clues, many times individuals draw the wrong conclusion and face embarrassment and rejection. The inability to quickly and easily determine if a ‘mutual attraction’ exists can be a significant impediment to romantic and/or sexual relations.

Finding another individual with whom one shares a mutual romantic and/or sexual interest is by no means a guarantee that romance or sexual relations will occur. Determining the availability of another individual with whom a ‘match’ exists presents another significant barrier to romance and sexual relations. With busy lives come busy schedules. Coordinating times and communicating availability becomes difficult and is often very time consuming, especially when multiple potential partners exist. The cumbersome process of sorting through all potential partners and matches and then determining their current availability presents a significant barrier to interaction.

Another hurdle to romance and sexual relations is the fact that interest levels and feelings tend to change over time. For example, many relationships begin with high sexual or romantic interest, but over time, this interest may dwindle. Additionally, one individual may still feel strongly for the other after a given period of time, while the other individual may have no interest whatsoever. Not being able to effectively determine the level of interest on an ongoing basis can result in confusion and embarrassment, and can significantly impede relations.

Lastly, with the advent of new ways to meet and communicate with others, like newspaper and magazine ads, telephone and video dating services, and online personals, information overload has become a significant impediment to romance and sexual relations. Keeping track of potential partners and individuals who share a reciprocal interest can be highly problematic. Not having quick, convenient and universal access to this information can create a significant barrier to romance and sexual relations.

Although numerous inventors have attempted to help facilitate the process of one individual meeting another individual or individuals for romance and/or sexual relations, virtually all have focused on processes or systems determining ‘matches’ based on comparing static ‘characteristic and criteria’ data of two individuals and determining if a ‘match’ exists.

U.S. Pat. No. 6,249,282 to Sutcliffe and Dunn (2000) discloses such a system for comparing the respective characteristic and criteria data of two individuals to provide a list of ‘matches’. ‘Matches’ are derived by comparing static criteria and characteristics data among individuals, like age, gender, ethnicity, religion, body type, smoking status, etc. The individuals themselves are not actively involved in the ‘matching’ process, other than their initial indication of preferences; they rely solely on the system to select and notify them of potential partners.

U.S. Pat. Nos. 4,173,016 to Dickson (1973), 4,348,744 to White (1981) and 5,086,394 to Shapira (1990) disclose similar processes of comparing stored, or pre-selected characteristic and criteria data to determine if a ‘match’ exists. Although each systems takes a slightly different approach in terms of execution, process for determining a match (e.g. algorithms that compute scores representing compatibility), and the method by which ‘matches’ are notified (e.g. pagers or radio transceivers), all use some form of static, pre-defined information to determine if a match exists.

None of the above referenced inventions (U.S. Pat. Nos. 6,249,282, 4,173,016, 4,348,744, 5,086,394) actively involve the individual in the ‘matching’ process, nor do they provide a method or system for determining and indicating availability of ‘matches’, determining ongoing romantic and/or sexual interest among individuals, allowing a user to view all individuals who have indicated an interest in him or her, or tracking and managing information about potential partners and ‘matches’.

Some inventions make use of more subjective, intuitive inputs instead of simply relying on static ‘characteristic and criteria’ data to determine if a ‘match’ exists. These inventions rely more heavily on individual involvement in determining ‘matches’ between individuals.

U.S. Pat. 5,950,200 to Sudai and Blumberg (1997) discloses one such method and apparatus for the detection of reciprocal interests or feelings and subsequent notification. This method and apparatus utilizes a computer to receive inputs from various persons indicating the identities of persons for whom they feel attraction or with whom they share mutual interests. The system collects this information and periodically searches for ‘matches’. No notification of interest occurs unless the system determines that a match in attraction or interest exists between both individuals. If a mutual attraction does not exist, only the computer system will be aware of the first individual's feelings for the second individual.

By relying on the existence of a ‘mutual attraction’ before communicating interest, the above mentioned invention (U.S. Pat. No. 5,950,200) fails to communicate a vital piece of information that has a significant impact on the creation of a ‘match’ between individuals—that being the fact that the first individual's expression of interest in the 2^{nd} individual may in fact cause the second individual to indicate an interest in the 1^{st} individual, thereby creating a match that would have otherwise not occurred. Communicating interest even though a ‘mutual attraction’ has not yet occurred is an important determining factor in the creation of a ‘match’ and also has a significant impact on the total number of potential ‘matches’.

In addition, the method of determining a ‘match’ described in U.S. Pat. No. 5,950,200 relies on the fact that the first individual is already aware that the second individual exists, when in reality, many times this is not the case. Relying on the premise that ‘matches’ can only be derived between individuals who are known to one another is severely limiting.

A further aspect of the above mentioned U.S. Pat. No. 5,950,200 discloses a method and apparatus for notification of interest whereby a 1^{st} individual indicates an interest in a 2^{nd} individual, but the 2^{nd} individual has not indicated interest in the 1^{st} individual. Using this method, the 2^{nd} individual is notified that ‘someone has indicated interest’ in them and is prompted to enter one or more IDs of people in whom he or she has an interest. Overall, this method provides very little value because it does not indicate the identity of the first individual to the second individual, thus making the likelihood of a match very small, especially when the pool of potential partners is relatively large.

In addition to the aforementioned patent, U.S. Pat. No. 5,950,200, U.S. Pat. No. 5,920,845 to Risemberg (1997) discloses a process for date matching by which individuals at a date matching event are assigned a unique identification code. Each participant wears the id code and spends a predetermined amount of time interacting and socializing with other participants. After a period of interaction, the date preferences of each participant are collected and analyzed to determine all occurring ‘mutual matches’. Similar to the method and apparatus described in patent U.S. Pat. No. 5,950,200, individuals are not notified of the romantic or sexual interest of other individuals unless a ‘mutual match’ has been identified.

In both of the above stated patents (U.S. Pat. Nos. 5,950,200 and 5,920,845), notification of romantic and/or sexual interest occurs only if it is determined that a ‘mutual match’ exists between individuals. This restriction severely limits the likelihood that a match will occur. In addition, there is no method for determining availability or logged-on (online) status of individuals with whom the user shares a mutual attraction, determining level of interest on an ongoing basis, allowing a user to view all other users who have indicated an interest in him or her, or tracking and accessing information relating to potential partners and “matches”. Combined, these limitations present a significant barrier to romance and/or sexual relations.

In summary, the heretofore known methods and apparatuses for identifying and communicating information about ‘matches’ among individuals suffer from a number of disadvantages:

a) Most rely on the comparison of static, ‘characteristic and criteria’ data of two individuals to determine if a ‘match’ exists, yet the process of identifying potential ‘matches’ often involves very intuitive inputs that are very subjective and not sufficiently captured by a comparison of static information like age, gender, race, religion, etc. This restricted approach to determining a match is severely limiting.

b) They rely on the existence of a ‘mutual attraction or match’ before communicating the interest or attraction of one individual in another individual. Notification does not occur unless a match in attraction or interest exists between both individuals. Given that the knowledge of one individual's interest in another individual can significantly influence the likelihood that a match will occur, failure to communicate this vital information upfront presents a sizable barrier to romantic and/or sexual relations.

c) They do not provide a means for determining the current availability or logged-on status of another individual with whom a romantic and/or sexual ‘match’ exists. This makes coordinating and communicating availability a very difficult and time consuming process, especially when a large number of potential partners exists. The absence of an efficient means of communicating availability significantly reduces the likelihood that interaction between individuals will occur.

d) They do not provide a method for determining the level of interest on an ongoing basis between individuals with whom a ‘match’ already exists and potential future partners. Interest levels and feelings tend to change over time and it is often difficult for individuals to determine if the same level of interest still exists. Without an effective means to determine the current level of romantic and/or sexual interest between previously ‘matched’ individuals and potential partners, the risks of possible embarrassment and rejection may prevent ongoing and future relations.

e) They do not provide a method or system for efficiently tracking and centrally managing information about potential partners and ‘matches’. The ability to quickly and conveniently access this information from any location increases the probability that individuals will connect for romance and/or sexual relations.

f) They do not provide a means for an individual to track and view all those individuals who have indicated an interest or attraction in him or her.

### Background of Invention—Objects and Advantages

Accordingly, several objects and advantages of my invention are:

a) To provide a ‘low risk’, non-threatening means of directly notifying and communicating the romantic and/or sexual interests of one individual in another individual regardless of whether or not a ‘mutual attraction’ or ‘match’ exists, thus minimizing the personal risks associated with embarrassment and rejection, while at the same time significantly increasing the likelihood that a ‘mutual match’ will occur by communicating an individual's interest upfront, a vital piece of information that can in itself serve to influence or even cause a ‘mutual match’ to occur.

b) To provide an effective method of determining and communicating a ‘mutual attraction’ between two or more individuals by comparing the attractions and interests of one individual with those of other individuals. If a reciprocal interest exists between two individuals, both individuals are notified that a ‘match’ has occurred, thus very directly and overtly confirming that a romantic and/or sexual ‘match’ exists between these individuals.

c) To provide a timely and efficient means of determining the current availability or logged-on status of another individual or individuals with whom mutual attraction or interest exists, thus facilitating interaction and significantly increasing the probability that two or more individuals with mutual interests will connect.

d) To provide a means of changing and communicating the level of ongoing attraction or interest among individuals, thus reducing the personal risks of embarrassment and rejection if interests or attraction levels differ between these individuals.

e) To provide an efficient means of inputting, tracking, and centrally managing information about potential partners and existing ‘matches’ that can be quickly and conveniently accessed, thus more effectively organizing information, saving time, and streamlining the retrieval of information.

f) To provide a confidential means for an individual to track and view all those individuals who have indicated an interest in him or her, regardless of whether or not a ‘mutual attraction’ or ‘match’ exists. This grouping of individuals may serve as a ‘pool’ of potential partners for future romantic and/or sexual relations, thus increasing the ease of identifying ‘matches’ in the future.

Further objects and advantages of the present invention will become apparent from a consideration of the figures and ensuing description.

### SUMMARY

The present invention overcomes the problems and disadvantages of the prior art by providing a user with an a low-risk, non-threatening means of directly notifying one individual of another individual's interest in him or her regardless of whether or not a mutual attraction exists. In addition, it provides an effective means for determining the current availability or logged-on status of another individual with whom a user shares a mutual interest or attraction, thus significantly facilitating their interaction.

The present invention also provides a means for a user to view other individuals who have indicated an interest in him or her and determine their current type and level of interest.

Lastly, the present invention allows a user to change his or her interest or attraction level in other individuals and communicate this change automatically in an indirect way, thus minimizing the potential for personal embarrassment.

Advantages of the invention will be set forth in part in the description which follows and in part will be obvious from the description or may be learned by practice of the invention. The objects and advantages of the invention will be realized and attained by means of the elements and combinations particularly pointed out in the appended claims and equivalents.

### DRAWINGS—FIGURES

The accompanying drawings, which are incorporated in and constitute a part of this specification, illustrate several embodiments of the invention and, together with the description, serve to explain the principles of the invention.

FIG. 1 is a block diagram of a computer system connected via the world wide web in accordance with a preferred embodiment of the present invention.

FIG. 2 is a flow chart showing steps performed in accordance with a preferred embodiment of the present invention to register a new user in the system.

FIG. 3 is a flow chart showing steps performed to allow a human user to register an attraction or interest as well as the steps taken to communicate attraction or interest.

FIG. 4 shows a screen shot of a page on the internet that includes a visual depiction of a means by which a user may register an interest or attraction for another user.

FIG. 5 shows an example of a screen shot of a form on the internet allowing a user to change their attraction level for another user and also input personal comments and notes about other users to whom they are attracted.

FIG. 6 is a flow chart showing the steps to allow a user to view all those users who have indicated an attraction or interest in him or her regardless of whether or not a ‘mutual attraction’ exists.

FIG. 7 shows an example of a screen shot of a ‘web form’ on the internet allowing a user to view all those users who have indicated an interest or attraction in him or her regardless of whether or not a ‘mutual attraction’ exists.

FIG. 8 is a flow chart showing the steps performed to determine if any of the users with whom a given user has a ‘mutual attraction’ are currently available or logged-onto the system now.

FIG. 9 shows a screen shot of a page on the internet displaying a list of a user's current ‘mutual attractions’ and also a visual indicator for those ‘mutual attractions’ that are available or logged-onto the system now.

FIG. 10 shows an example of an e-mail message indicating one user's interest in another user, with a link back to that user's profile and user specific information.

FIG. 11 shows an example of an e-mail message indicating a ‘mutual attraction’ between two users, with a link back to the other user's profile and user specific information.

### DETAILED DESCRIPTION OF THE PREFERRED EMBODIMENTS

Reference will now be made in detail to the preferred embodiments of the invention, examples of which are illustrated in the accompanying drawings. Wherever possible, the same reference numbers will be used throughout the drawings to refer to the same or like parts.

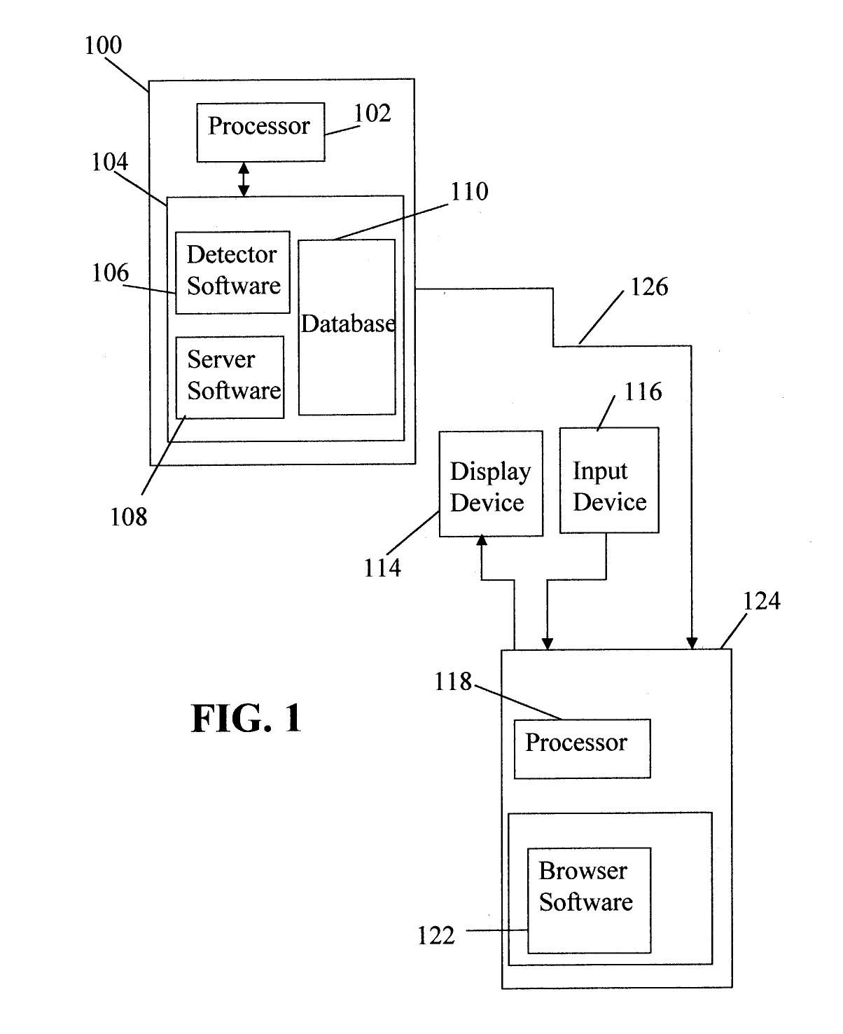

FIG. 1 shows a block diagram of a user's computer system 124 connected to another computer system, or group of computer systems 100 via the world wide web in accordance with a preferred embodiment of the present invention. Computer system 124 includes a processor 118 and browser software 122. System 124 preferably connects to a display device 114, such as a display screen, and to an input device 116, such as a mouse or touchpad. Computer system 100 includes a processor 102 and memory 104. Memory includes detector software 106, server software 108, and a database 110. Database 110 contains information relating to attractions and/or interests entered by human beings.

Computer system 124 is connected to computer system 100 via the Internet or an intranet through connection 126. Computer system 124 includes appropriate software to enable computer system 124 to communicate with computer system 100 over connection 126.

It will be understood by persons of ordinary skill in the art that computer systems 100 and 124 can include additional processors, memory, network connections, I/O devices, software, etc. that are not shown in the Figures for the sake of clarity of example. The present invention can be implemented on a wide variety of hardware, including those shown in FIG. 1, or other suitable hardware configurations, such as network computers (NCs), systems that bring the World Wide Web to TV, or Personal Data Assistants. (e.g. Palm Pilots, etc.)

In an alternate preferred embodiment (not shown), computer system 100 includes an interactive telephone input system that allows a user to input attraction or interests to detector software 106 using the keys on a touchtone telephone or a similar device.

The present invention described herein provides an effective method for individuals to register and communicate an interest in or attraction for another individual. These people are called “objects”. The term “interest” includes emotional interests, such as like, love, attraction, lust, sexual interests, or other emotional feelings. The term “interests” may also include non-emotional interests.

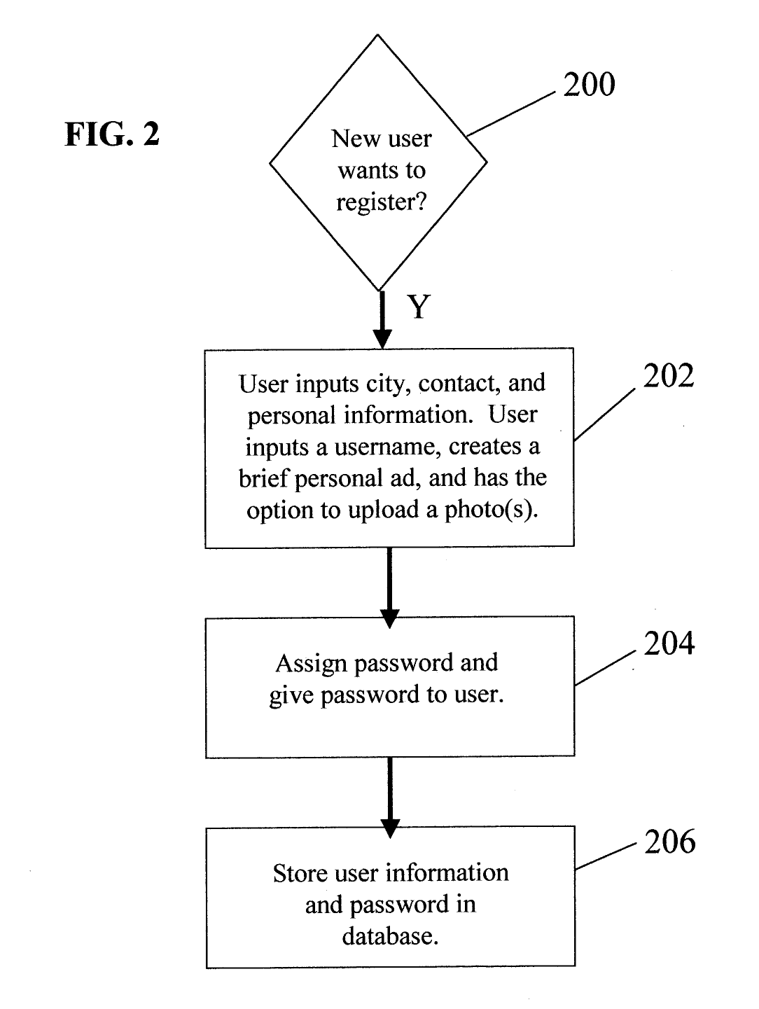

FIGS. 2-11 are flow charts and screen shots showing steps performed and related graphical displays in accordance with the present invention. The steps of FIGS. 2-11 are performed by processor 102 and preferably are implemented as computer instructions of software 106 executed by processor 102. Each of these flow charts and screen shots is discussed below in turn.

FIG. 2 is a flow chart showing steps performed in accordance with a preferred embodiment of the present invention to register a new user in the system. The registration operation is generally, but not always, performed.

In step 200, the detector software 106 determines that a new user wants to register with the system. In step 202, detector software prompts the user to enter his or her city, contact information, and personal characteristics. In addition, detector software 106 prompts the user to input a unique username or ID (which will become his or her unique identity on the system), create a brief personal ad, and upload a photo(s) if desired. Collectively, this information makes up a user's profile in the system.

In step 204, a password is assigned to the user and communicated to the user. Step 206 stores the unique user name, password, and all information entered by the user in memory 104. If a particular implementation of the invention includes a registration procedure, the user will be required to enter his or her password before he or she is able to enter new objects and/or interests into the database in the future or modify a previous selection.

It should be understood that, although the described system collects personal and characteristic information from users in order to create a user profile for the purpose of creating a ‘personal ad’, the present invention may collect a wide variety of information and is not limited to the collection of information used to create a ‘personal ad’.

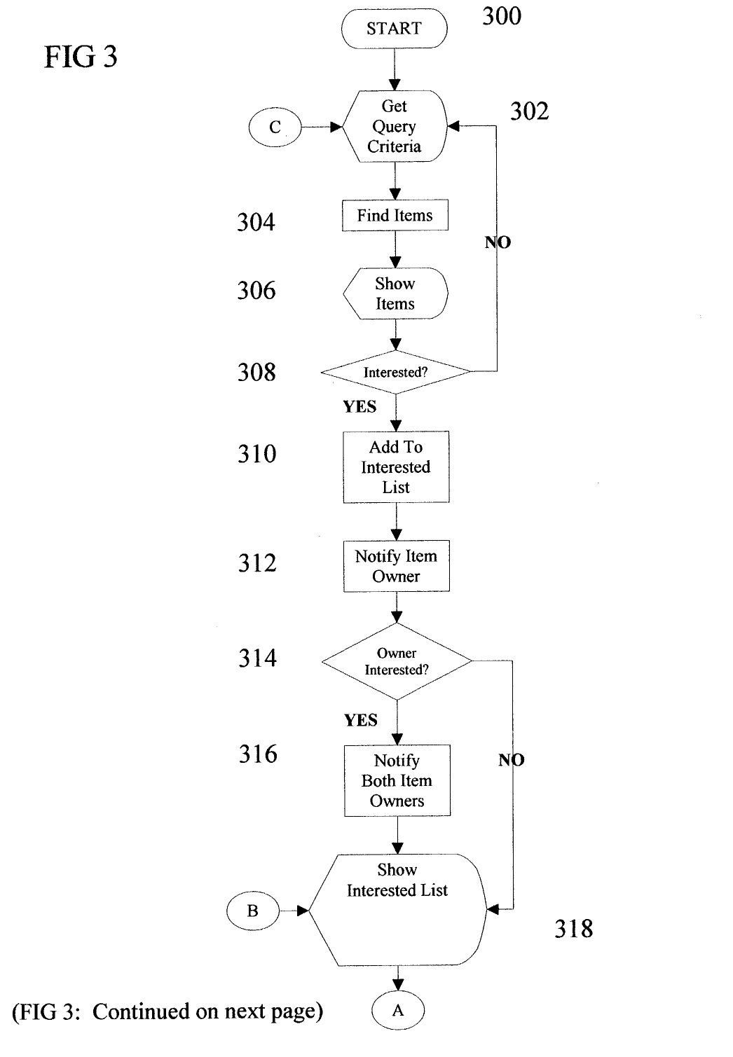

FIG. 3 is a flow chart showing steps performed to allow a human user to register attraction or interest and the means by which a mutual attraction is determined and interests are communicated.

In step 300, a user (User X) logs into the system using their unique username and password. In Step 302, User X performs a query to find users (or more generically objects) that match his or her specified criteria. Queries may be performed based on any information that is stored about another user in database 110. Examples of such queries would include, but are not limited to, viewing all user profiles in a particular city, viewing all users with certain physical characteristics, viewing only users with photos, or viewing all users who are currently logged onto the system. In Steps 304 and 306, Processor 102 executes this query and displays the resulting user profiles on User X's display device 114.

User X then views the user profiles that correspond to his or her query and determines, based on a review of the users' profiles and related information, whether or not he or she is interested or attracted to any of the other users. If no attraction exists, User X may simply perform another query or exit the system. In Step 308, if an attraction or interest does exist, detector software 104 determines that User X wants to enter a new object. (i.e. register an attraction or interest in another user)

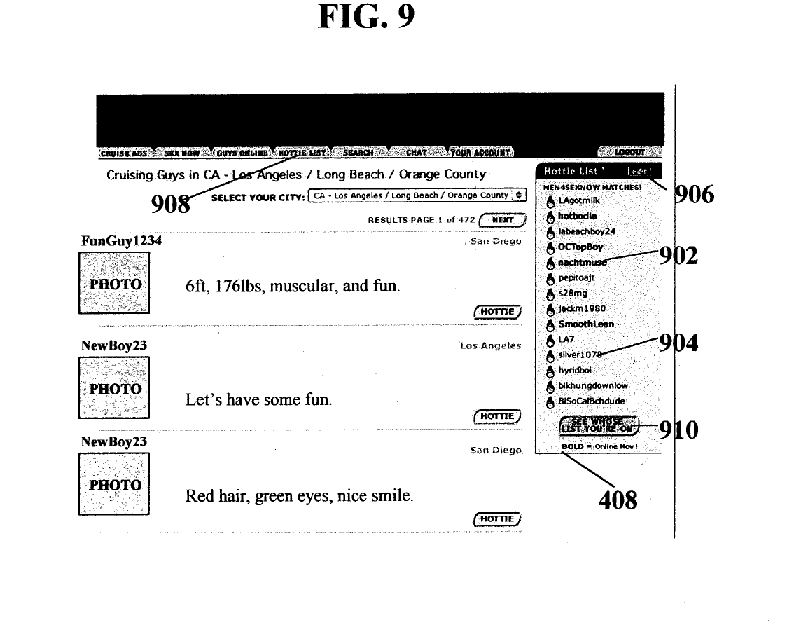

In Step 310, the new object (User Y) is added to the list of users that User X is interested in or attracted to. User X's interest in User Y is stored in database 110. In Step 312, User Y is notified via email that User X is interested in or attracted to User Y. Notification is performed regardless of whether or not a ‘mutual attraction’ exists. Notification includes a user's username or ID. (see FIG. 10 for example email)

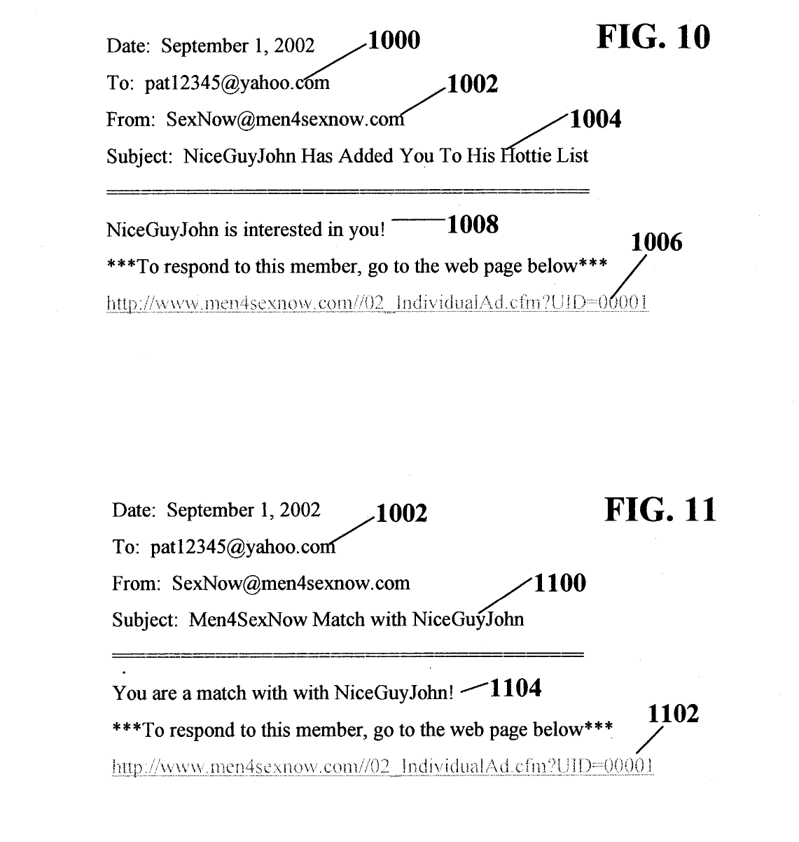

In Step 314, processor 102 using detector software 104 and database 110, determines if User Y has indicated a reciprocal interest in or attraction for User X. In Step 316, if User Y has also indicated an interest in or attraction for User X, then both User X and User Y are notified immediately that a ‘mutual match’ has occurred. Notification includes a user's username or ID. (See FIG. 11 for example email)

In Step 318, a ‘web form’ existing on the world wide web is displayed to User X indicating all those users that User X has indicated an interest in or attraction for, including the newly added User Y. The default level of interest or attraction is indicated as “I'm Interested.” Step 320 allows User X to close the form without making any changes to the type or level of attraction. Step 322 allows User X to permanently remove another user from his or her list. If a user is removed, Step 326 removes that user from User X's list in database 110. Step 324 allows User X to change the type or level of interest that he or she has in another user. If changes to interest levels or attraction are made, Step 328 updates these changes in database 110. Step 330 allows a user to add additional ‘free form’ comments or information about other users. If comments are added, Step 332 updates these comments in database 110.

It should be understood that, although the system described in the preferred embodiment detects matches for two persons, the system can be expanded to detect matches among any number of persons. In addition, the type of attraction or interest does not have to ‘match’ exactly in order for a mutual attraction to occur. It is simply necessary for two users to register an interest or attraction for one another (whatever that level of attraction may be) for a ‘mutual attraction or match’ to occur.

In an alternate embodiment, the types or levels of attraction must match exactly for a mutual attraction to occur and for users to be notified that a ‘mutual match’ exists. In addition, notification may be performed on a periodic interval or at a predetermined time, like once per day. Furthermore, the level of attraction may default to a different type or level of attraction, or none at all.

In still a further embodiment, instead of using a ‘web form’ to display all the users that a given user has indicated an interest in, a list of usernames or Ids could be emailed, sent via telephone, transmitted to a PDA via a wireless connection, or communicated using any other appropriate notification method.

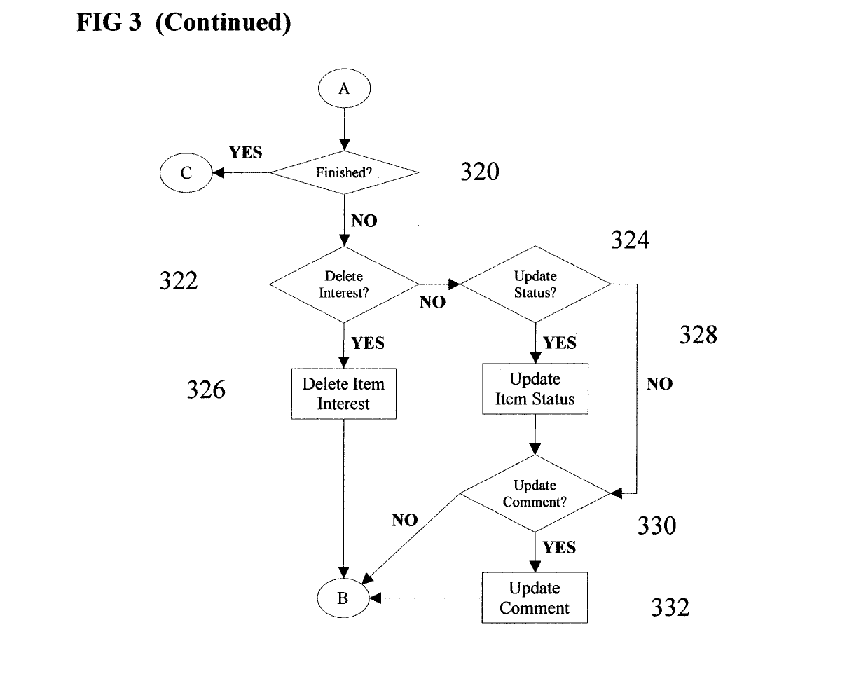

FIG. 4 is a screen shot of an example of a user (User X) query that would be displayed on User X's display device 114. FIG. 4 displays all the user profiles that match User X's specified criteria. In this example, User X does not currently have a mutual attraction or interest in any other users of the system, as indicated by the “Hottie List” display tool 408. Each user profile displayed in FIG. 4 includes a user's unique username 400, photo 402 (if available) and ad copy and personal characteristics 404. Next to each user profile is a “Hottie” button 406 that allows the user performing the query to register an attraction or interest in that specific user.

Although button 406 is the preferred means of registering an attraction or interest in another user, the present invention may be implemented using any other suitable means of registering another object (i.e. user), including, but not limited to, typing in the user's unique username or ID, etc.

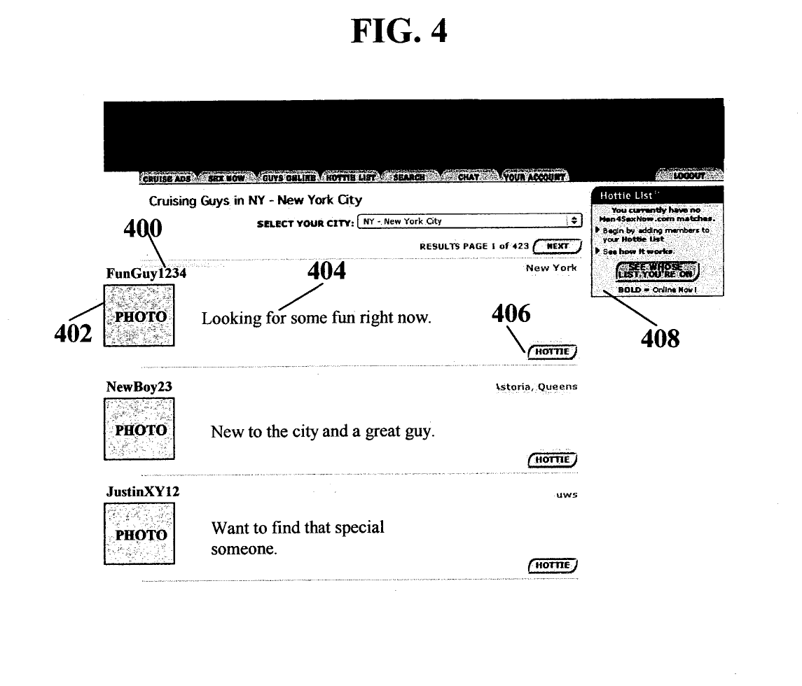

FIG. 5 shows an example of a “web form” displayed on display device 114 by browser 122 of FIG. 1, allowing a user to view a list of other users he or she has indicated an interest in and input or change his or her attraction level for another user. This form can be implemented using HTML, Java, or any other suitable method.

In FIG. 5, the user chooses between different levels of attraction, including, but not limited to: “I'm Interested” 506, “Let's Have Sex” 508, temporarily “Inactivate” 510 and permanently “Remove” 512. The user uses input device 116 of FIG. 1 to enter information and browser software 122 sends the information to server software 108, where it is passed to detector software 106. The User may also enter his or her own private comments or notes about the other users on his on her list in the notes area 514. In addition, each user's unique username 502 and photo 504 are linked to that user's individual web page where a more detailed profile is available for that user. When all changes or additions have been made, the user may “Save Changes” 518. All changes are then stored in database 110.

Another preferred embodiment allows the user to enter his or her unique username or ID and enter an attraction or interest in another user using an interactive telephone system. In this embodiment, the user calls a predetermined telephone number and is asked by a prerecorded message to enter his or her user username or ID using the keypad of their telephone. The user is then prompted to enter the username or ID of a person to whom he or she is attracted. The system then prompts the user to enter a type of interest of attraction. Once the user has entered information using such an interactive telephone system, detection and notification proceed in any of the ways described herein.

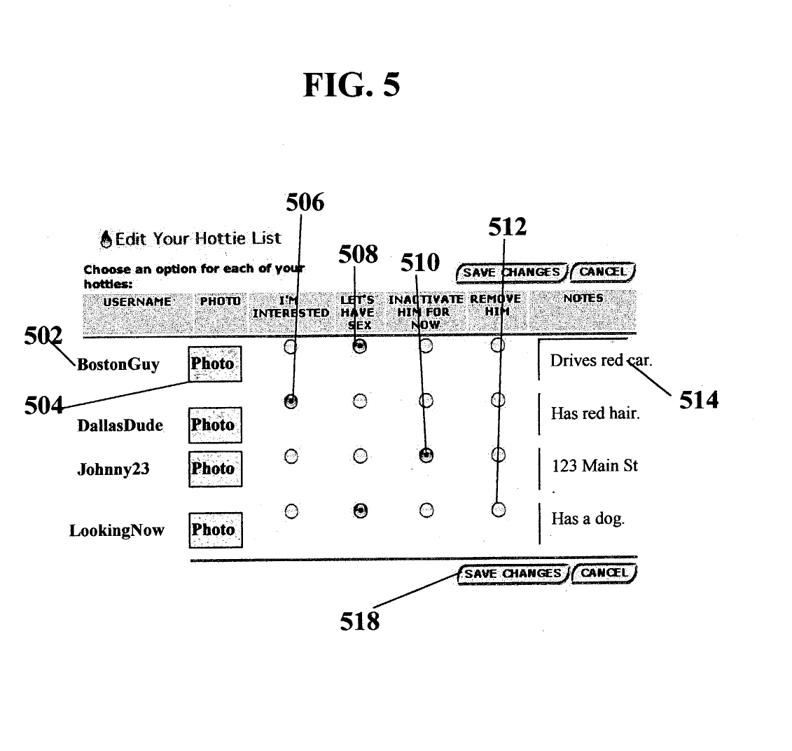

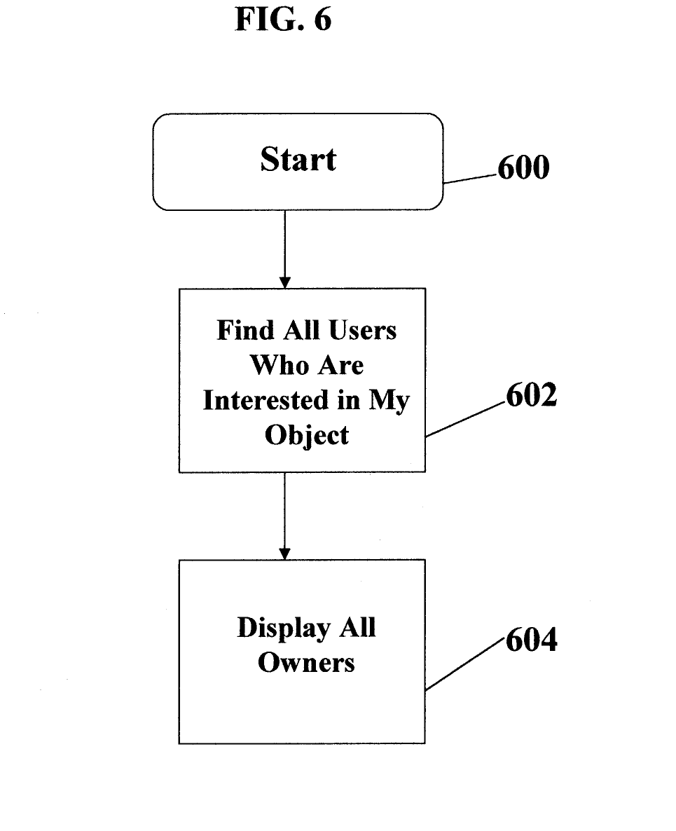

FIG. 6 is a flow chart of the preferred embodiment showing the steps to allow a user (User X) to view all those users who have indicated an interest in him or her regardless of whether or not a match in attraction or interest exists. In Step 600, a user (User X) logs onto the system using his or her unique username and password. In Step 602, processor 102 using the detector software 104 queries database 110 to find all users who have indicated an interest in or attraction for User X. In Step 604, all users that have indicated an interest in User X are displayed on User X's display device 114. FIG. 7 illustrates a ‘web’ form used to graphically display all users interested in User X.

An alternate embodiment allows a user to receive a list of usernames and profiles of all those users who have indicated an interest in him or her via other suitable delivery methods. Such methods may include, but are not limited to, email, telephone or a hand held wireless device like a PDA.

FIG. 7 shows a screen shot of the preferred embodiment of a form on the internet allowing a user (User X) to view all other users who have indicated an interest in him or her regardless of whether or not a ‘mutual attraction’ exists. FIG. 7 displays the unique usernames 902 and photos 904 of users that are interested in User X. In addition, each user's level of interest in User X (the object in this case) is also indicated. In FIG. 7, level of attraction or interest is indicated as ‘I'm Interested’ 706 or ‘Lets Have Sex’ 708. In addition, each username 702 and photo 704 is connected or linked back to that user's profile information stored in database 110.

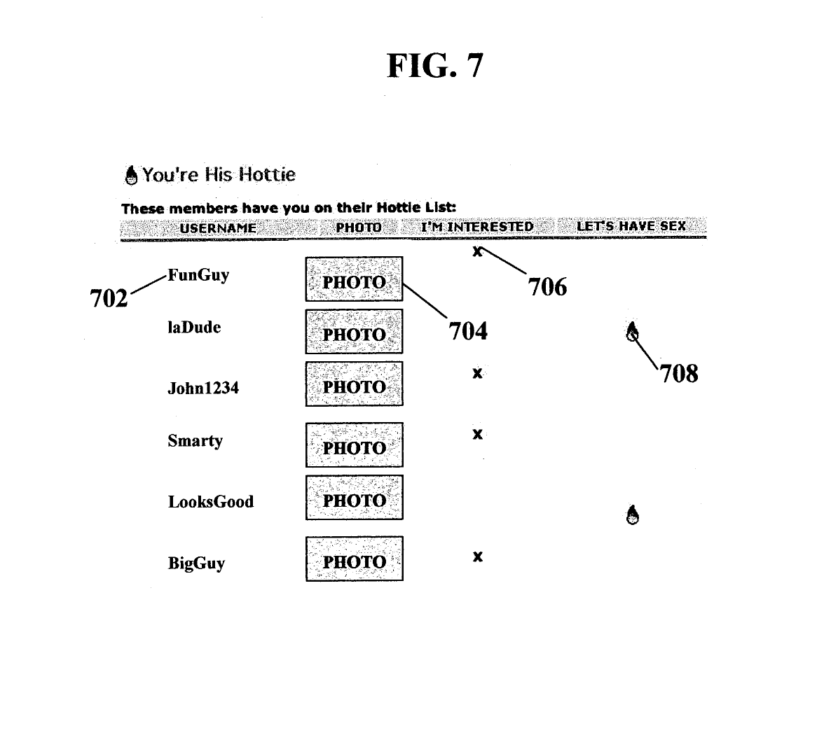

FIG. 8 is a flow chart of the preferred embodiment showing the steps performed to display users who share a mutual attraction or interest and to determine if a user with a ‘mutual attraction’ is currently available or logged-on now. In Step 800, a user (User X) logs onto the system with his or her unique username and password. In Step 802, processor 102 using detector software 106 queries database 110 to find all users who are interested in User X and with whom User X is also interested. Step 804 then displays all ‘mutual attractions’ on User X's display device 114 and also indicates which ‘mutual attractions’ are currently available or logged-on to the system now.

In an alternate embodiment (not shown), the system indicates the availability or logged-on status of all other users that have indicated an interest in or attraction for a given user. For example, User X may view the availability of all those users who have indicated an interest in him, regardless of whether or not User X has indicated an interest in them.

In still another embodiment (not shown), the system indicates the availability or logged-on status of all other users that a given individual has indicated an interest in or attraction for. For example, User X may view the availability of all those users he or she has indicated an interest in, regardless of whether or not they have indicated an interest in User X.

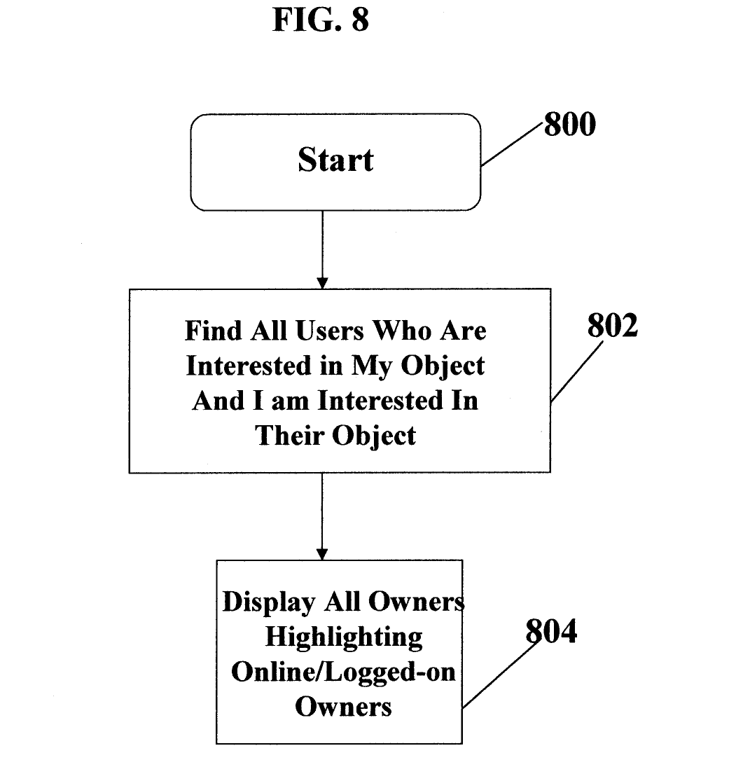

FIG. 9 shows a screen shot of the ‘Hottie List’ display tool 408, which displays a user's (User X) ‘mutual attractions’ on User X's display device 114 and also indicates current availability or logged-on status of User X's ‘mutual attractions’. The ‘Hottie List’ display tool 408 is displayed along with each user query. Mutual matches in attraction or interest are displayed in the ‘Hottie List’ display tool 408. Matches that are logged-on the system or available now are indicated by bold type font 902. Matches that are not logged-on now are not in bold type 904. All Usernames displayed on the ‘Hottie List’ tool are linked back to each respective user's profile and personal information.

The ‘Hottie List’ display tool 408 also includes a ‘See Whose List You're On’ button 910, that allows a user to view all other users who are interested in him or her. By clicking on this button 910, the user is taken to his or her ‘You're His Hottie’ form described in FIG. 7.

By selecting the Edit button 906 or the ‘Hottie List’ navigation tab 908, the user is taken to his or her ‘Hottie List’ form described in FIG. 5, where he or she can make changes to interest levels and add personal comments about other users.

In another preferred embodiment, the logged-on status of a ‘mutual attraction’ could be communicated by a host of other means, including, but not limited to, icons, text, images, or any means suitable to indicate the availability or logged-on status of a ‘mutual attraction.’

In yet another embodiment, indication of availability or logged-on status of a user with whom another user shares a mutual interest is accomplished via email, telephone, or wireless PDA.

In an alternative embodiment, the ‘Hottie List’ display tool 408 and related ‘mutual attractions’ do not show up on each query results page. Instead, this list of ‘mutual attractions’ could reside on a separate web page that could be accessed by the user. In another embodiment, indications of a ‘mutual attraction’ and the logged-on status of a ‘mutual attraction’ could be communicated to the user by any other suitable means, including, but not limited to, the incorporation of a ‘mutual attraction’ and logged-on now indicator as part of the user's profile.

FIG. 10 shows an example of an e-mail message indicating one user's interest in another user. This email is sent regardless of whether or not a mutual attraction between these users exists. In this example, User X has registered an interest in or attraction for User Y. An email is automatically sent from a mailbox 1002 residing on computer system 100 on behalf of User X to User Y (similar to how a trusted 3^{rd} party or close associate may be used by individuals to initiate first contact). This email is sent directly to User Y's email address 1000 (User Y's email address is not available to User X, thus protecting User Y's privacy) indicating that User X is interested in User Y 1004. The email includes a link 1006 back to User X's profile and personal information, allowing User Y to quickly and easily determine if there is a mutual interest in User X.

It should be noted that although in the preferred embodiment, the subject heading 1004 and email text of the email message 1008 contains specific text (i.e. “UserX Has Added You To His Hottie List”, and “UserX is interested in you!”), this text may be altered or change to reflect the specific type of attraction or interest in question.

FIG. 11 shows an example of an e-mail message indicating a ‘mutual attraction’ between two individuals. In this example, both User X and User Y have registered an interest in or attraction for each other. An email is automatically sent from a mailbox 1002 residing on computer system 100 to both Users indicating that a ‘match’ has occurred 1100. The email includes a link 1102 back to the other User's profile and personal information and serves as definitive confirmation that both users share a mutual interest in one another.

It should be noted that although in the preferred embodiment, the subject heading 1100 and email text of the email message 1104 contains specific text (i.e. “Men4SexNow Match with UserX”, and “You are a match with UserX!”), this text may be altered or changed to reflect the specific type of attraction or interest in question.

Advantages

From the description above, a number of advantages of the present invention become evident:

a) Unlike other techniques that require a ‘mutual attraction’ to exist before notification occurs, my method notifies an individual of another individual's interest regardless of whether or not a mutual attraction exists. By communicating this vital information up front, the likelihood that a match will occur is significantly increased.

b) The ability for a user to determine the current availability or logged-on (online) status of an individual with whom he or she shares a ‘mutual attraction’ greatly facilitates interaction and significantly increases the probability that these individuals with ultimately connect.

c) The ability to readily determine and gage ongoing level of attraction or interest among ‘mutual matches’ and potential future partners reduces the personal risks of embarrassment and makes it easier to determine if similar interest levels exist and if both individuals are still compatible.

d) The ability for a user to track and view all those individuals who have indicated an interest or attraction for him or her increases the ease by which a user may identify, select, communicate with, and keep track of future potential partners.

e) Unlike other systems that do not provide a means for users to input, track, and centrally manage information about potential partners and ‘mutual matches’, my system provides a effective tool for organizing information, saving time, and streamlining the retrieval of information.

Conclusion, Ramifications, and Scope of Invention

Accordingly, the reader will see that the present invention significantly enhances a user's ability to interact with individuals with whom he or she shares a mutual attraction, as well as with individuals who have indicated an interest in said user, making the process faster, easier and more efficient. Furthermore, the present invention has the additional advantages in that:

It allows a user to directly communicate his or her interest in another individual in a non-embarrassing, low-risk way by using the present invention as a ‘trusted’ 3^{rd} party to communicate interest or attraction.

It provides a tangible means for a user to determine the availability or logged-on status of another individual with whom said user shares a ‘mutual attraction’.

It allows a user to readily change and effectively communicate ongoing level of attraction or interest in ‘mutual matches’ and potential future partners.

It provides a user with the means to track and view all those individuals who have indicated an interest in him or her, as well determine their current level of interest or attraction.

It improves a user's ability to track and centrally manage information about potential partners and ‘mutual matches’.

Although the description above contains many specifications, these should not be construed as limiting the scope of the invention but as merely providing illustrations of some of the presently preferred embodiments of this invention. Other embodiments will be apparent to those skilled in the art from consideration of the specification and practice of the invention disclosed herein. It is intended that the specification and examples be considered as exemplary only, with a true scope of the invention being indicated by the following claims.

I claim:

1. A method that facilitates interaction between a person and other individuals he or she has an interest in or an attraction for, comprising the steps, performed by a processor of a data processing system having a memory of:
receiving input from a first user indicating a user ID of a specific person in whom the first user has an interest;
receiving input from a second user indicating a user ID of a specific person in whom the second user has an interest;
determining if there is a ‘mutual match’ in attraction or interest between the first and second individuals; and
indicating the current availability or logged-on status of individuals who share a mutual interest or attraction,
whereby a person is able to quickly and easily determine if an individual with whom he or she shares a mutual interest is currently available or logged-on to the system, thus making it significantly more likely that these individuals will ultimately connect and interact.

2. The method of claim 1, wherein the step of receiving input from a first user indicating a user ID of a person includes receiving input from the first user through the World Wide Web.

3. The method of claim 1, wherein the step of receiving input from a first user indicating a user ID of a person includes receiving input from the first user by way of an interactive telephone system.

4. The method of claim 1, wherein an individual is notified of another individual's interest regardless of whether or not a ‘mutual attraction’ exists.

5. The method of claim 1, wherein the step of determining a mutual match does not require that the types or levels of interest match exactly, only that a mutual interest of some sort exists between both individuals.

6. The method of claim 1, wherein the step of determining a mutual match requires that the types or levels of interest match exactly.

7. The method of claim 1, wherein individuals are notified when a mutual attraction occurs between said individuals.

8. The method of claim 1, wherein the determination of availability or logged-on status of a person sharing a mutual interest with a given user occurs as a result of that person logging-onto a given system or website using his or her username and password.

9. The method of claim 1, wherein indication of availability or logged-on status of an individual sharing a mutual attraction for a given user is accomplished through a web page on the internet.

10. The method of claim 1, wherein indication of availability or logged-on status of an individual sharing a mutual attraction for a given user is accomplished by email.

11. The method of claim 1, wherein indication of availability or logged-on status of an individual sharing a mutual interest with a given user is accomplished by telephone, pager, or wireless PDA.

12. The method of claim 1, wherein a user is able to view the availability or logged-on status of individuals that he or she is attracted to or interested in, regardless of whether or not said individuals have a mutual attraction.

13. The method of claim 1, wherein a user is able to view all other individuals who have indicated an interest in or attraction for said user.

14. The method of claim 1, wherein a user is able to view the availability or logged-on status of individuals that have indicated an interest in or attraction for said user.

15. The method of claim 1, wherein a user is able to determine another individual's type or level of interest in said user.

16. The method of claim 1, wherein a user is able to change or modify his or her interest type or level of interest in another individual.

17. The method of claim 1, wherein a user is able to centrally manage, organize and track information on other individuals he or she is interested in or attracted to.

18. An apparatus that notifies people when other people they are attracted to or interested in are available, comprising:
means for receiving input from a first user indicating a user ID of a specific person in whom the first user has an interest;
means for receiving input from a second user indicating a user ID of a specific person in whom the second user has an interest;
means for determining whether the user ID of the person in whom the first user has an interest matches a user ID of the second user and for determining whether the user ID of the person in whom the second user has an interest matches a user ID of the first user; and
means for, coupled to the determining means, indicating the current availability or logged-on status of individuals who share a mutual interest or attraction.
